(19) United States
(12) Patent Application Publication
(10) Pub. No.: US 2011/0258216 A1
(43) Pub. Date: Oct. 20, 2011

(54) USABILITY ENHANCEMENTS FOR BOOKMARKS OF BROWSERS

(75) Inventors: TASSANEE K. SUPAKKUL, EULESS, TX (US); JANKI Y. VORA, LEWISVILLE, TX (US)

(73) Assignee: INTERNATIONAL BUSINESS MACHINES CORPORATION, ARMONK, NY (US)

(21) Appl. No.: 12/763,558

(22) Filed: Apr. 20, 2010

(51) Int. Cl. G06F 3/048; G06F 17/30

(52) U.S. Cl. 707/769; 715/821; 715/716; 715/760; 707/E17.014

(57) ABSTRACT

Bookmarks can reference uniquely addressed Web resources. Bookmark annotations can include user specified, digital content related to uniquely addressed Web resources. An user interface of an annotative bookmark manager can permit users to create, edit, and delete bookmark annotations. A browser interface of a Web browser can include a bookmark section that displays a listing of textual descriptors for bookmarks. An annotation handler can present one of the bookmark annotations within the browser user interface responsive to a detection of a mouseover event for a corresponding textual descriptor. The bookmark annotation can be automatically hidden when the mouseover event ends. Bookmark prioritization enables listing of highly weighted parameterized bookmarks in a user friendly manner.

### BACKGROUND

The present invention relates to the field of Web browsers and, more particularly, to usability enhancements (including bookmark annotations and time/event dependent prioritizations) for bookmarks of browsers.

Bookmarks, sometimes referred to as “Favorites”, are an invaluable feature of Web browsers. Bookmarks allow users to capture a link to Web site/page for quick and easy access. However, with the enormous amount of information and Web sites/pages, a user's list of bookmarks often becomes cumbersome and unmanageable.

Most Web browsers include the capability for a user to group bookmarks into user-named folders. There are also a variety of software applications and/or services designed to consolidate bookmarks from multiple Web browsers, predict new Web sites of interest, and share bookmarks among other users and devices.

Despite these tools, users must often take the time to think about or remember contextual information before selecting a bookmark. That is, conventional bookmark management tools lack the ability to capture the user's knowledge regarding bookmark usage or background context. Failure to correctly predetermine which bookmark to select results in time lost loading and reviewing the target Web page.

For example, a software developer may have many links to various Web pages about JAVA. When looking for the bookmark that corresponds to a specific article, the developer must determine which is the correct bookmark based on the bookmark title and/or uniform resource locator (URL) and their memory.

In another example, User A enjoys reading a large quantity of Web comics. Each Web comic updates with a different frequency. Therefore, before User A selects a Web comic bookmark, they must remember if it is a day of the week that the bookmarked Web comic updates. Conventional bookmark management tools require User A to either store this information (i.e., memory, external lists) or embed the knowledge in a static bookmark structure, such as a folder for each day of the week. A change in the embedded knowledge (i.e., update frequency) of a bookmark then requires a manual change to the bookmark structure.

### BRIEF SUMMARY

One aspect of the disclosure can include a method, computer program product, and system for improving usability of bookmarked content. In this aspect, a listing of textual descriptors for a user's bookmarks can be presented within a user interface. Each of the textual descriptors can correspond to one of the bookmarks. Each of the bookmarks can reference a uniquely addressed Web resource, such as a Web page. Each of the user's bookmarks can be ones that were previously added to the listing responsive to a user selection. A positioning of an interface pointer can be detected as being substantially positioned over one of the textual descriptors, wherein substantially positioned means positioned within proximity of the textual descriptor to trigger a related mouseover event. The mouseover event can be triggered based on the detecting of the positioning. Responsive to the mouseover event, a previously established bookmark annotation corresponding to one of the bookmarks can be looked-up. The corresponding bookmark can be one of the user's bookmarks that correspond to the one textual descriptor that the interface pointer is positioned over. The previously established bookmark annotation can have been established in response to a user action. The user's bookmarks can comprise a set of different annotations, each uniquely corresponding to one of the user's bookmarks. Responsive to the mouseover event, the previously established bookmark annotation can be presented within the user interface before a user has opted to navigate to the uniquely addressed Web resource that the bookmark references. When the interface pointer is moved so that it is no longer positioned substantially over the one of the textual descriptors, the previously established bookmark annotation can be responsively hidden from the user interface. When the bookmark annotation or the corresponding textual descriptor are selected for navigating, a navigation event can be triggered to navigate to the uniquely addressed Web resource that the bookmark references. Responsive to the navigation event, the corresponding Web resource can be presented within the user interface and the previously established bookmark annotation can be hidden from the user interface.

Another aspect of the disclosure can be for a system comprising a Web browser, an annotative and prioritization bookmark manager, an annotation handler, a plurality of bookmarks, and a plurality of bookmark annotations. Each of the bookmarks can reference a uniquely addressed Web resource. Each of the bookmark annotations can include user specified, digital content related to the uniquely addressed Web resource. Each of the bookmark annotations can correspond to one of the bookmarks. The annotative and prioritization bookmark manager can include an annotate user interface operable to permit users to create, edit, and delete bookmark annotations. Further, annotative and prioritization bookmark manager can enable prioritization of bookmarks, where prioritization can be based on weighed parameters. Prioritized bookmarks can be listed within a user interface in a user friendly manner. The Web browser can include a browser user interface comprising a bookmark section. The bookmark section can display a listing of textual descriptors for the bookmarks. The annotation handler can present one of the bookmark annotations within the browser user interface responsive to a detection of a mouseover event for a textual descriptor corresponding to one of the bookmarks that corresponds to the presented bookmark annotation. The bookmark annotation can be automatically hidden when the mouseover event ends.

### BRIEF DESCRIPTION OF THE SEVERAL VIEWS OF THE DRAWINGS

FIG. 1 is a schematic diagram illustrating a system that provides a user with an automated capability to annotate and prioritize Web bookmarks in accordance with embodiments of the inventive arrangements disclosed herein.

FIG. 2 is a flow chart of a method describing user operation of the annotative bookmark manager in accordance with an embodiment of the inventive arrangements disclosed herein.

FIG. 3 is a flow chart of a method describing the presentation of multimedia bookmark annotations by the annotative bookmark manager in accordance with an embodiment of the inventive arrangements disclosed herein.

FIG. 4 is a flow chart of a method describing the prioritization of bookmarks by the annotative bookmark manager in accordance with an embodiment of the inventive arrangements disclosed herein.

FIG. 5 is an illustration of the presentation of a multimedia bookmark annotation presented within a Web browser in accordance with an embodiment of the inventive arrangements disclosed herein.

FIG. 5A illustrates the addition of a multimedia bookmark annotation.

FIG. 5B illustrates the user-configuration of the prioritization parameters for a bookmark.

### DETAILED DESCRIPTION

The present invention discloses a solution that provides a user with the means to annotate and prioritize Web bookmarks. An annotative and prioritization bookmark manager can be used to capture data for a multimedia bookmark annotation to be associated with a specified bookmark. The multimedia bookmark annotation can then be dynamically presented to the user when the specified bookmark is moused-over. Further, the annotative bookmark manager can allow the user to define prioritization parameters for a bookmark. Based upon the values of the prioritization parameters, the annotative and prioritization bookmark manager can adjust the position of the bookmark in the overall list of bookmarks.

As will be appreciated by one skilled in the art, aspects of the present invention may be embodied as a system, method or computer program product. Accordingly, aspects of the present invention may take the form of an entirely hardware embodiment, a software embodiment (including firmware, resident software, micro-code, etc.) where the software embodiment can include a storage medium (which can be a tangible, physical, non-transitory storage medium) within which the software resides, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer program stored on a computer readable storage medium may be propagated over a distance via a computer readable signal medium.

The computer readable storage medium can be a tangible, non-transitory medium. The computer readable storage medium can be a physical device or part of a physical device in which information is digitally encoded. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

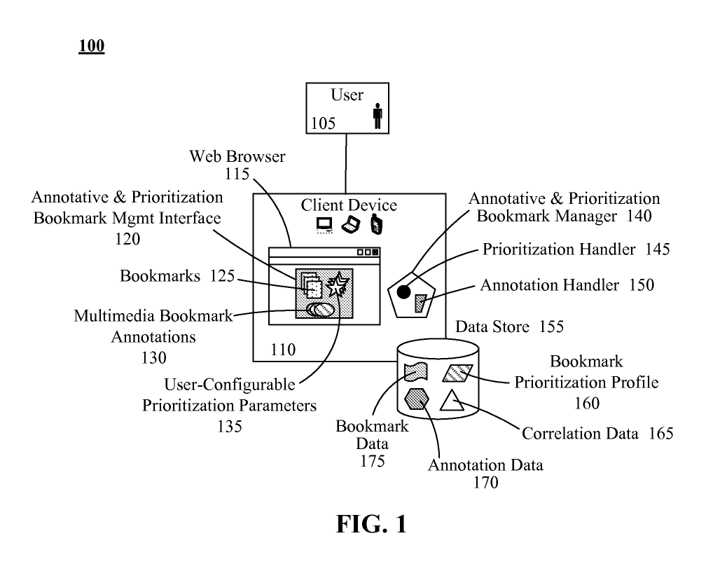

FIG. 1 is a schematic diagram illustrating a system 100 that provides a user 105 with an automated capability to annotate and prioritize Web bookmarks 125 in accordance with embodiments of the inventive arrangements disclosed herein. In system 100, the annotative and prioritization bookmark manager 140 can capture multimedia bookmark annotations 130 and user-configurable prioritization parameters 135 for a user's 105 bookmarks 125.

A bookmark 125 can represent a shortcut to a Web page of a Web site stored within the data store 155 of the client device 110. Selection of a bookmark 125 can result in the corresponding Web page being rendered by the Web browser 115. Bookmarks 125 can be stored as bookmark data 175 in a data store 155 of the client device 110. A bookmark 125 can be a unique uniform resource locator (URL), a domain name registered with a domain name service (DNS), or other reference to an addressable network resource (retainable within a browser 115).

The Web browser 115 can represent a software application installed upon the client device 110 configured to render Web pages written using standardized Web programming languages, such as hypertext markup language (HTML) and extensible markup language (XML). The Web browser 115 can communicate with Web servers (not shown) over the Internet using standardized communication protocols, such as hypertext transfer protocol (HTTP), to access the requested Web pages. Web browser 115 includes rich internet interfaces (RH) (e.g., user interfaces of rich internet applications (RIA)), internet-enabled desktop gadgets or widgets, and the like. In one embodiment, Web browser 115 can have a corresponding graphical user interface (GUI), through which a user interacts. In another embodiment, the Web browser 115 can include a voice user interface (VUI), which can be used in addition to a GUI and/or in place of a GUI.

The annotative and prioritization bookmark manager 140 can represent a software application running on the client device 110 configured to provide an automated means for capturing user 105 knowledge about their bookmarks 125 and performing operations based upon the captured knowledge to enhance bookmark 125 selection. The annotative and prioritization bookmark manager 140 can be configured to interact with Web browser 115.

The annotative and prioritization bookmark manager 140 can include an annotative and prioritization bookmark management interface 120 to facilitate interactions with the user 105. The annotative and prioritization bookmark management interface 120 can represent a graphical user interface presented upon the client device 110. The annotative and prioritization bookmark management interface 120 can be launched from the Web browser 115 and/or directly from the client device 110 without an active Web browser 115.

In another embodiment, functionality of the annotative and prioritization bookmark management interface 120 can be integrated within the interaction elements of the Web browser 115. For example, menu items corresponding to functions of the annotative and prioritization bookmark management interface 120 can be inserted into the existing menus of the Web browser 115.

The annotative and prioritization bookmark management interface 120 can be utilized to capture/present multimedia bookmark annotations 130 and user-configurable prioritization parameters 135 for the user's 105 bookmarks 125. The user's 105 bookmarks 125 can also be displayed within the annotative and prioritization bookmark management interface 120. Depending upon implementation, the bookmarks 125 can be selected from within the annotative and prioritization bookmark management interface 120 for viewing in the Web browser 115.

A multimedia bookmark annotation 130 can represent a user-determined data item for association with a specific bookmark 125. The multimedia bookmark annotation 130 can support various data types—text, image, audio, and/or video. Once captured, the multimedia bookmark annotation 130 can be presented to the user 105 prior to selection of the bookmark 125, providing a quick and recognizable context. When a video or audio annotation 130 are created, a time limited (or fidelity limited) portion of the video/audio annotation can be presented. In one embodiment, the user-determined data item can be a copied portion of a Web page. When the annotation 130 includes text, the text can be indexed for searching and/or content based prioritizing purposes.

In one embodiment, the annotation 130 can also be automatically extracted from a Web site without requiring explicit user selection. For example, a thumbnail of an associated Web site can be captured (as an image, for example) and stored as an annotation 130. In another example, all text can be captured and indexed, where “key terms” are used to create an automatic annotation, which a user 105 can optionally edit.

To illustrate annotations 130 by example, in one implementation, user 105 peruses the list of bookmarks 125 within the Web browser 115. As the user 105 hovers over a bookmark 125, the multimedia bookmark annotation 130 associated with the bookmark 125 can be displayed. Thus, the user 105 can easily determine whether the bookmark 125 is the desired bookmark 125. When different types of annotations (text, images, video, audio, etc.) exist, user 105 can configure their interface (115) to establish display preferences for the presented annotation 130. For example, can establish that a textual annotation (if any) be shown, an image be shown, a video be shown, and combinations thereof. In one embodiment, different checkboxes in a presentation configuration window can be used to select presentation preferences for the annotations 130.

In another embodiment, the multimedia bookmark annotation 130 can include multiple data items of differing data types. For example, the multimedia bookmark annotation 130 can include an image with user-entered text.

Capture and presentation of the multimedia bookmark annotations 130 can be performed by the annotation handler 150 component of the annotative and prioritization bookmark manager 140. The annotation handler 150 can store captured multimedia bookmark annotations 130 as annotation data 170. The relationship between a bookmark 125 and its multimedia bookmark annotation 130 can be stored by the annotation handler 150 as correlation data 165. Annotation handler 150 can use manual user input (explicitly captured content, user entered text, media, and the like), automatically captured input (captured directly from an associated Web site in accordance with a set of programmatic rules), and combinations thereof.

It should be appreciated that, while some tools allow the creation of notes for a bookmark 125 or shortcut, such notes are not dynamically displayed to the user 105 without additional actions made by the user 105. For example, notes can be associated with the icon of a bookmark 125 via the DETAILS tab of the PROPERTIES window. In order for the user 105 to read the notes at a later time, the user 105 would need to navigate to the icon for the bookmark 125 and access the DETAILS tab of the PROPERTIES window. In one embodiment, security restrictions can also be established for annotations 130 so that sensitive content is not displayed or be otherwise available to other users (other than user 105) or displayed when the device 110 is used in a public or other security compromised environment.

In another contemplated embodiment, the annotation data 170 can include the correlation data 165. For example, a reference to the corresponding bookmark 125 can be a database field of an annotation data 170 record for a multimedia bookmark annotation 130.

The user-configurable prioritization parameters 135 can represent conditions set by the user 105 for changing the order in which the bookmarks 125 are listed in the Web browser 115 and/or annotative and prioritization bookmark management interface 120. Examples of user-configurable prioritization parameters 135 can include, but are not limited to, a priority level, a triggering event, a recurrence frequency, a target location, and the like.

The annotative and prioritization bookmark manager 140 can capture the user-configurable prioritization parameters 135 in a bookmark prioritization profile 160. A prioritization handler 145 component of the annotative and prioritization bookmark manager 140 can be configured to dynamically adjust the placement of bookmarks 125 when one or more user-configurable prioritization parameters 135 are met.

For example, at midnight, the prioritization handler 145 can query the bookmark prioritization profile 160 for entries associated with the change in date. The bookmark data 175 of the bookmarks 125 corresponding to the resultant entries contained in the bookmark prioritization profile 160 can be modified by the prioritization handler 145. That is, the bookmark 125 file can be moved within the bookmark data 175 as if the user 105 had performed the task manually.

The annotative and prioritization bookmark manager 140 can also include a variety of event listeners (not shown) to support implemented triggering events. As in the above example, the annotative and prioritization bookmark manager 140 would include and utilize a time/date event listener.

In another embodiment, the annotative and prioritization bookmark manager 140 can be a Web service interacting with the Web browser 115 or annotative and prioritization bookmark management interface 120 over the Internet.

In yet another embodiment, the functionality of the annotative and prioritization bookmark manager 140 can be expanded to operate using bookmark data 175 stored in a social bookmarking environment. In such an embodiment, the annotative and prioritization bookmark manager 140 can be a server-side application or Web service accessed via the social bookmarking Web site.

In still another embodiment, the functionality of the annotative and prioritization bookmark manager 140 can include a text-to-speech option that can read the text of a multimedia bookmark annotation 130. In the case where the multimedia bookmark annotations 130 is an image, accommodations can be made to capture an alternate text description of the image similar to the alternate text attribute used in HTML. Such an embodiment can provide great benefit to users 105 with visual impairments.

Additionally, storage and implementation configurations of the annotative and prioritization bookmark manager 140 can exist to accommodate the operating limitations of different types of client devices 110. For example, a resource-constrained client device 110, such as a smart phone, can utilize a lighter version of the annotative and prioritization bookmark manager 140 and remotely store annotation data 170 and/or correlation data 165 on an associated data server. Alternately, the robustness of the features offered by the annotative and prioritization bookmark manager 140 can be reduced for a constrained operating environment.

As used herein, presented data store 155 can be a physical or virtual storage space configured to store digital information. Data store 155 can be physically implemented within any type of hardware including, but not limited to, a magnetic disk, an optical disk, a semiconductor memory, a digitally encoded plastic memory, a holographic memory, or any other recording medium. Data store 155 can be a stand-alone storage unit as well as a storage unit formed from a plurality of physical devices. Additionally, information can be stored within data store 155 in a variety of manners. For example, information can be stored within a database structure or can be stored within one or more files of a file storage system, where each file may or may not be indexed for information searching purposes. Further, data store 155 can utilize one or more encryption mechanisms to protect stored information from unauthorized access.

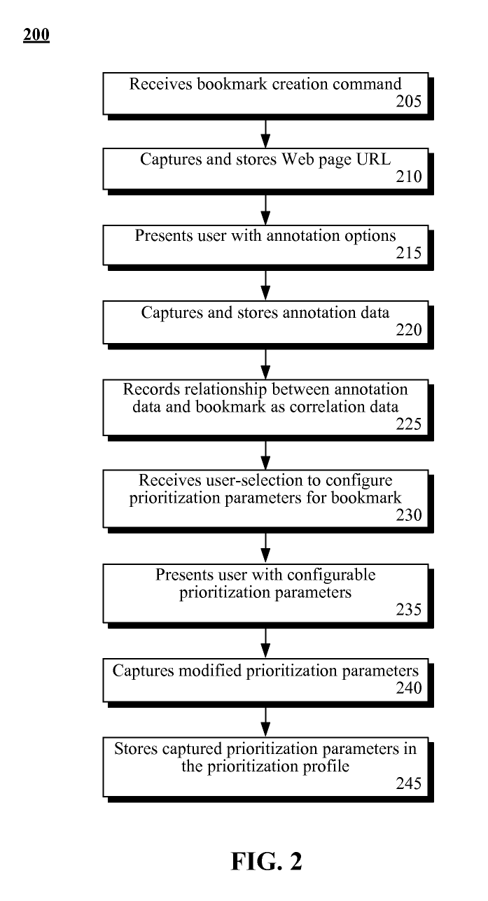

FIG. 2 is a flow chart of a method 200 describing user operation of the annotative bookmark manager in accordance with embodiments of the inventive arrangements disclosed herein. Method 200 can be performed within the context of system 100 or any other system configured to dynamically prioritize bookmarks based on user-configured prioritization parameters and present multimedia bookmark annotations.

Method 200 can begin in step 205 where the annotative bookmark manager can receive a bookmark creation command. Step 205 can illustrate the embodiment of the present invention where the annotative bookmark manager includes a bookmark creation capability. In lieu of an inherent bookmark creation capability, step 205 can be modified to allow the annotative bookmark manager to detect the selection of a bookmark creation command by the user as through a Web browser menu.

In step 210, the uniform resource locator (URL) of the Web page can be captured and stored. Annotation options can then be presented to the user in step 215. In step 220, the annotation data can be captured and stored. The relationship between the annotation data and the bookmark can be recorded as correlation data in step 225.

In step 230, the annotative bookmark manager can receive a user-selection to configure prioritization parameters for the bookmark. The configurable prioritization parameters can be presented to the user in step 235. In step 240, modifications to the prioritization parameters can be captured. The captured prioritization parameters can be stored in the prioritization profile in step 245.

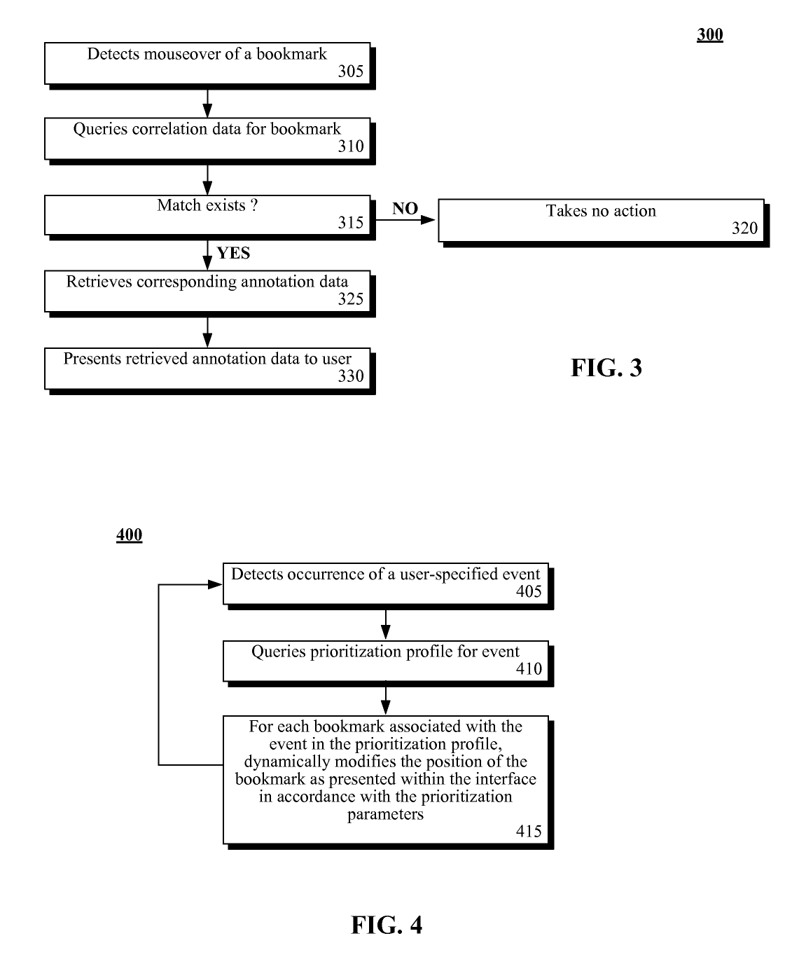

FIG. 3 is a flow chart of a method 300 describing the presentation of multimedia bookmark annotations by the annotative bookmark manager in accordance with embodiments of the inventive arrangements disclosed herein. Method 300 can be performed within the context of system 100 and/or in conjunction with method 200.

Method 300 can begin in step 305 where the annotative bookmark manager can detect a mouseover, flyover, or other triggering event in other embodiments, (such as a mouse selection of a characteristic icon, right-mouse clicking a bookmark, receiving a hot-key combination when a bookmark has focus, etc.) of a bookmark in the listing of bookmarks. The correlation data can then be queried for entries matching the bookmark being moused-over in step 310. In step 315, it can be determined if the correlation data contains any matching entries.

When no matches exist, step 320 can execute where the annotative bookmark manager takes no further action. When matches exist, the corresponding annotation data can be retrieved in step 325. In step 330, the retrieved annotation data can be presented to the user such as a tooltip. In other embodiments, the annotation data can be presented in a pop-up window, in a designated section of a browser, etc.)

It should be noted that step 330 can require invocation of additional software applications depending on the data type of the annotation data retrieved in step 325. That is, retrieval of an audio file in step 325 can involve launching of an audio playback program in step 330 to play the audio file.

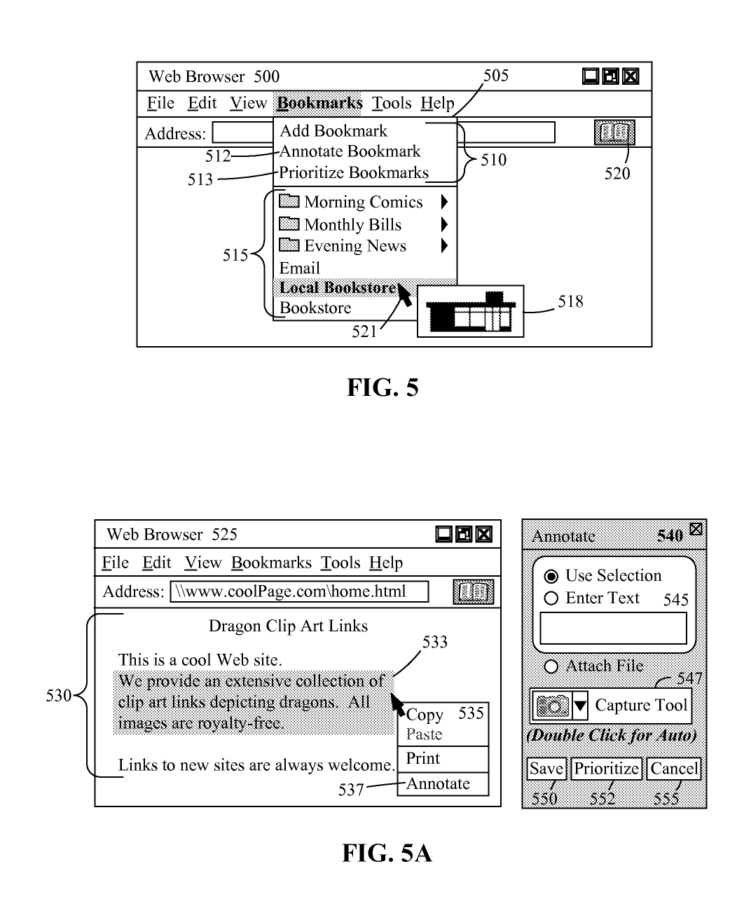

FIG. 4 is a flow chart of a method 400 describing the prioritization of bookmarks by the annotative bookmark manager in accordance with embodiments of the inventive arrangements disclosed herein. Method 400 can be performed within the context of system 100 and/or in conjunction with method 200.

Method 400 can begin in step 405 where the annotative bookmark manager can detect the occurrence of a user-specified event. The prioritization profile can be queried for the event in step 410. In step 415, the position of each bookmark within the interface that matches the user-specified event can be dynamically modified in accordance with the prioritization parameters. Method 400 can be modified to apply to filtering bookmarks instead of prioritizing them. Further, a cut-off threshold can be established (which combines prioritizing and filtering) so that only the top N number of bookmarks are presented, where others bookmarks of lesser priority are hidden, require a user-selection of an expansion list button to be shown, etc.

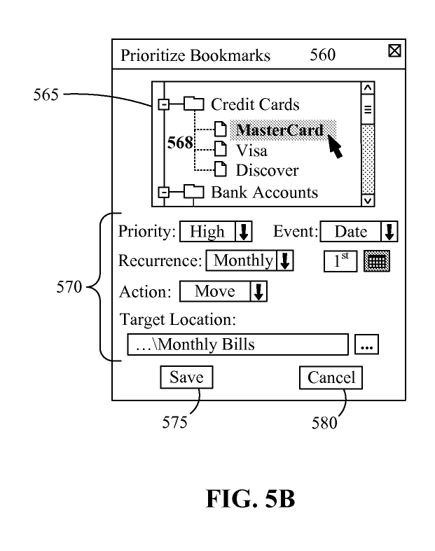

FIG. 5 is an illustration of the presentation of a multimedia bookmark annotation 518 presented within a Web browser 500 in accordance with embodiments of the inventive arrangements disclosed herein. The illustration shown in FIG. 5 can be utilized within the context of system 100 and/or in conjunction with methods 200, 300, and/or 400.

It is important to note that the functionality of the annotative bookmark manager presented in FIGS. 5, 5A, and 5B is for illustrative purposes only, and is not intended to present a limitation of an embodiment of the present invention.

As shown in this example, the user has accessed a bookmark menu 505 within a Web browser 500. The bookmark menu can present the user with bookmark commands 510 and a listing of stored bookmarks 515, including any defined file structure (i.e., folders and subfolders). In this example, the bookmark commands 510 can include menu items performed by the Web browser 500 as well as those supported by the annotative bookmark manager—an annotate bookmark command 512 and a prioritize bookmarks command 513.

When the user places the mouse pointer 521 over a bookmark 515, the multimedia bookmark annotation 518 associated with the bookmark 515 can be presented in a pop-up window. As shown in this example, the user can view the multimedia bookmark annotation 518 before selecting the “Local Bookstore” bookmark 515. Based on the multimedia bookmark annotation 518, the user can determine if this bookmark 515 is for the desired bookstore Web site.

In one embodiment, the annotation 518 for the bookmarked page is presented when the corresponding bookmark 521 has focus/is selected. The showing of the annotation 518 occurs when the browser 500 is not displaying the Web page, which corresponds to the annotation 518. That is the annotation 518 can be a preview of the associated Web page, which is only displayed in the browser 500 once the bookmark 512 is selected. In one embodiment, clicking on the annotation 518 (or taking some other related action) can result in the corresponding Web site being loaded in the browser 500. The showing of the Web site in the browser 500 can cause the annotation 518 to automatically be hidden or to be no longer displayed.

The Web browser 500 can also include a launch button 520 for the annotative bookmark manager. Selection of the launch button 520, annotate bookmark command 512, or prioritize bookmarks command 513 can invoke the annotative bookmark manager.

FIG. 5A can illustrate the capture of annotation data using the annotative bookmark manager launched from with the Web browser 525. In this example, the user can be viewing a Web page 530 within the Web browser 525. The user may select some content 533 presented by the Web page 530 and want to use the selected content 533 as a multimedia bookmark annotation 518.

To create the multimedia bookmark annotation 518, the user could use the launch button 520 or annotate bookmark command 512 shown in FIG. 5. Access to the annotative bookmark manager can also be provided via an annotate menu option 537 contained in the right-click context menu 535. Selection of any of these options 512, 520, or 537 (or others, such as a hot-key combination, a toolbar icon, etc.) can result in the presentation of the annotation window 540.

It should be noted that the annotative bookmark manager can be configured to create a bookmark 515 for the Web page 530 should one note already exist when the user selects the annotate menu option 537.

The annotation window 540 can present the user with annotation options 545 for creating a multimedia bookmark annotation 518. In this example, the “Use Selection” annotation option 545 can be preset based upon the user's content selection 533 within the Web page 530. The annotation options 545 can be presented without a selected option 545 when content 533 is not selected or the annotation window 540 is invoked via the launch button 520 or annotate bookmark command 512.

One additional option of the annotation window 540 can include a capture tool 547, which captures content displayed in browser 525. For example, tool 547 can include a snapshot option for selecting a region of the displayed Web site and creating an image from it. Tool 547 can also include a text capture option for selecting portions of text shown in the Web site (e.g., content selection 533, for example). The tool 547 can have an automatic function, operable to capture all content of the Web site of browser 525 when selected. Content captured via tool 547 is stored as an annotation for the Web site of browser 525.

The annotation window 540 can also include a save button 550, a prioritize button 552, and a cancel button 555. The save button 550 can be used to store the annotation data entered into the annotation window 540. The cancel button 555 can discard any unsaved annotation data and close the annotation window 540.

Selection of the prioritize button 552 from the annotation window 540 or the prioritize bookmarks command 513 can present the user with the prioritize bookmark window 560 shown in FIG. 5B. The prioritize bookmark window 560 can include a bookmark display 565, user-configurable prioritization parameters 570, a save button 575, and a cancel button 580.

In the bookmark display 565, the user can be presented with a listing of their stored bookmarks 568 and any organizational structure. Upon selection of a bookmark 568 within the bookmark display 565, the user can then modify its associated prioritization parameters 570. Should the selected bookmark 568 have stored prioritization parameters 570, the currently stored values for the prioritization parameters 570 can be displayed.

The prioritization parameters 570 can allow the user to define the conditions under which a specified action should be performed upon the associated bookmark 568. As shown in this example, on the first day of every month, the “MASTERCARD” bookmark 568 can be moved from its current location to a folder called “Monthly Bills”.

Thus, the user can have all the bookmarks 568 used for paying bills online moved to the specified folder. The prioritization parameters 570 can be further expanded to include additional conditions for releasing or undoing the repositioning of bookmark 568. As such, the annotative bookmark manager can temporarily store the original location of the bookmark 568 prior to repositioning.

For example, a time period can be specified such that the “MASTERCARD” bookmark 568 is moved from the “Monthly Bills” folder to the “Credit Cards” folder when the time period has elapsed.

The functionality of the annotative bookmark manager can be further extended to interface with other supporting software applications for the scheduling or definition of triggering events. For example, a date-based event can use an existing calendar application or widget installed upon the user's client device.

In one embodiment, a user can be permitted to explicitly set prioritization values (1-10) or levels (high, medium, low) for one or more bookmarks, which are used as a factor when computing a priority associated with the corresponding set of bookmark. Further, bookmarks can be placed in specific categories, where these categories each have priority values associated with them, so that some categories are prioritized higher than others. In one embodiment, dynamic conditions, such as frequency of use, can be monitored for a bookmark or related Web site and used as a factor for prioritizing the bookmarks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for improving usability of bookmarked content comprising:
within a user interface, presenting a listing of textual descriptors for a user's bookmarks, each of the textual descriptors corresponding to one of the bookmarks, each of the bookmarks referencing a uniquely addressed Web resource, wherein each of the user's bookmarks were previously added to the listing responsive to a user selection;
detecting a positioning of an interface pointer substantially over one of the textual descriptors;
triggering a mouseover event based on the detecting of the positioning;
responsive to the mouseover event, looking-up a previously established bookmark annotation corresponding to one of the bookmarks, wherein the corresponding bookmark is one of the user's bookmarks that corresponds to the one textual descriptor that the interface pointer is positioned over, wherein the previously established bookmark annotation was established responsive to a user action, wherein a plurality of the user's bookmarks comprise a plurality of different annotations, each uniquely corresponding to one of the user's bookmarks;
responsive to the mouseover event, presenting the previously established bookmark annotation within the user interface before a user has opted to navigate to the uniquely addressed Web resource that the bookmark references;
when the interface pointer is moved so that it is no longer positioned substantially over the one of the textual descriptors, responsively hiding the previously established bookmark annotation from the user interface;
when the bookmark annotation or the corresponding textual descriptor are selected for navigating, triggering a navigation event to navigate to the uniquely addressed Web resource that the bookmark references; and
responsive to the navigation event, presenting the corresponding Web resource within the user interface and responsively hiding the previously established bookmark annotation from the user interface.

2. The method of claim 1, wherein the previously established bookmark annotation comprises an audio annotation that is audibly presented within the user interface responsive to the mouseover event.

3. The method of claim 1, wherein the previously established bookmark annotation comprises a textual description of the Web site previously manually entered by a user to whom the listing corresponds.

4. The method of claim 1, wherein the previously established bookmark annotation comprises a portion of a video, which is played when the annotation is presented responsive to the mouseover event, wherein the portion of video is a portion of a longer video available upon navigating to the uniquely addressed Web resource.

5. The method of claim 1, wherein the previously established bookmark annotation comprises a portion of an audio file, which is audibly played when the annotation is presented responsive to the mouseover event, wherein the portion of the audio file is a portion of a longer audio file available upon navigating to the uniquely addressed Web resource.

6. The method of claim 1, wherein the previously established bookmark annotation comprises a sub-portion of a Web site corresponding to the uniquely addressed Web resource, said sub-portion of the Web site having been previously selected using a capture tool that captured the sub-portion of Web site as the Web site was being presented via the user interface;

7. The method of claim 1, wherein the previously established bookmark annotation comprises a thumbnail image of a Web site, which is the uniquely addressed Web resource referenced by the corresponding bookmark.

8. The method of claim 1, further comprising:
for each of the bookmarks, establishing a bookmark specific, time variable condition;
prioritizing at a specific time the bookmarks relative to each other, wherein prioritization values used when prioritizing each of the bookmarks varies based on the time variable condition in relationship to the specific time at which the prioritizing occurs;
ordering the bookmarks in accordance with results of the prioritizing;
ordering the textual descriptors within the listing in accordance with the ordering of the corresponding bookmarks, wherein the prioritizing, the ordering of the bookmarks, and the ordering of the textual descriptors occurs responsive to the application comprising the user interface being instantiated or occurs responsive to a user selection within the user interface, which the presenting of the listing occurs in response to, wherein the ordering of the textual descriptors occurs before the presenting of the listing so that as presented, the listing of the textual descriptors is in accordance with the ordering.

9. The method of claim 8, wherein one of the time variable conditions for one of the bookmarks, is associated with a periodic updating of resource content of the uniquely addressed Web resource, said method further comprising:
determining when the updating of resource content occurs; and
for the bookmark referencing the uniquely addressed Web resource having the resource content, determining a prioritization value for the bookmark at a given time, wherein the prioritization value varies in direct proportion to the given time and it's relation with the time the resource content was updated, wherein the prioritization value is greater the closer the given time is to a time at which the resource content was most recently updated.

10. The method of claim 8, wherein one of the time variable conditions for one of the bookmarks is associated with a user calendar maintained for a specific user within a calendaring application, wherein the variable condition and the related resource referenced by the corresponding bookmark have a defined relationship;
when determining a priority value for the bookmark associated with the user calendar, accessing records of the calendaring application for the specific user; and
calculating the priority value for the bookmark based on content from the accessed records and specifics of the defined relationship.

11. The method of claim 8, further comprising:
attaching at least one of the bookmarks to a user selected calendared event of a calendaring application;
when prioritizing the bookmarks, utilizing the user selected calendared event as the time variable condition for each bookmark, which has been attached to the user selected calendared event.

12. The method of claim 1, further comprising:
detecting an occurrence of a user-specified prioritization event for at least one of the bookmarks;
querying a previously established, user configured bookmark prioritization profile for a record corresponding to the detected user-specified prioritization event, wherein said record defines a plurality of user-configured prioritization parameters for the at least one bookmark; and
dynamically modifying a position of the textual descriptor that corresponds to the at least one bookmark within the listing for the at least one bookmark within the listing is based upon the plurality of user-configured prioritization parameters.

13. The method of claim 12, wherein the plurality of user-configured prioritization parameters comprises at least three of a triggering event, a priority level, a recurrence frequency, an action definition, and a termination action.

14. The method of claim 1, wherein the user interface is a graphical user interface of a Web browser, wherein the Web browser natively lacks support for bookmark annotations, which includes lacking support for a user to defined bookmark annotations and for presenting the bookmark annotations responsive to related mouseover events, wherein the Web browser comprises a plug-in that provides the support for the bookmark annotations, which includes providing support for a user to define bookmark annotations and for presenting the bookmark annotations responsive to related mouseover events.

15. The method of claim 1, wherein the user interface is a graphical user interface of a Web browser, wherein the Web browser natively lacks support for bookmark annotations, which includes lacking support for a user to defined bookmark annotations and for presenting the bookmark annotations responsive to related mouseover events, wherein the Web browser subscribes to a Web service provided by a network element remotely located from the a client upon which the Web browser runs, wherein the Web service provides the support for the bookmark annotations, which includes providing support for a user to define bookmark annotations and for presenting the bookmark annotations responsive to related mouseover events.

16. A computer program product comprising a tangible computer readable storage medium having computer usable program code embodied therewith, the computer usable program code operable to run on hardware, said computer program product comprising:
computer usable program code stored on a tangible storage medium operable to, within a user interface, present a listing of textual descriptors for a user's bookmarks, each of the textual descriptors corresponding to one of the bookmarks, each of the bookmarks referencing a uniquely addressed Web resource, wherein each of the user's bookmarks were previously added to the listing responsive to a user selection;
computer usable program code stored on a tangible storage medium operable to detect a positioning of an interface pointer substantially over one of the textual descriptors;
computer usable program code stored on a tangible storage medium operable to trigger a mouseover event based on the detecting of the positioning;
computer usable program code stored on a tangible storage medium operable to, responsive to the mouseover event, look-up a previously established bookmark annotation corresponding to one of the bookmarks, wherein the corresponding bookmark is one of the user's bookmarks that corresponds to the one textual descriptor that the interface pointer is positioned over, wherein the previously established bookmark annotation was established responsive to a user action, wherein a plurality of the user's bookmarks comprise a plurality of different annotations, each uniquely corresponding to one of the user's bookmarks;
computer usable program code stored on a tangible storage medium operable to, responsive to the mouseover event, present the previously established bookmark annotation within the user interface before a user has opted to navigate to the uniquely addressed Web resource that the bookmark references;
computer usable program code stored on a tangible storage medium operable to, when the interface pointer is moved so that it is no longer positioned substantially over the one of the textual descriptors, responsively hide the previously established bookmark annotation from the user interface;
computer usable program code stored on a tangible storage medium operable to, when the bookmark annotation or the corresponding textual descriptor are selected for navigating, trigger a navigation event to navigate to the uniquely addressed Web resource that the bookmark references; and
computer usable program code stored on a tangible storage medium operable to, responsive to the navigation event, present the corresponding Web resource within the user interface and to responsively hide the previously established bookmark annotation from the user interface.

17. A system for improving usability of bookmarked content comprising:
at least one tangible storage medium comprising a Web browser, an annotative and prioritization bookmark manager, an annotation handler, a plurality of bookmarks, and a plurality of bookmark annotations, each of which are digitally encoded within the tangible storage medium in a computer-readable fashion, wherein the Web browser, the annotative bookmark manager, and the annotation handler are operable to be run on hardware, wherein each of the plurality of bookmarks references a uniquely addressed Web resource, wherein each of the bookmark annotations comprises user specified, digital content related to the uniquely addressed Web resource and where each of the bookmark annotations corresponds to one of the bookmarks, wherein:
the annotative and prioritization bookmark manager comprises an annotate user interface operable to permit users to create, edit, and delete bookmark annotations; and
the Web browser comprises a browser user interface comprising a bookmark section, wherein said bookmark section is operable to display a listing of textual descriptors for the bookmarks, wherein the annotation handler is operable to present one of the bookmark annotations within the browser user interface responsive to a detection of a mouseover events for a textual descriptor corresponding to one of the bookmarks that corresponds to the presented bookmark annotation, wherein the bookmark annotation is automatically hidden when the mouseover event ends.

18. The system of claim 17, wherein the annotative and prioritization bookmark manager further comprises a prioritization handler and wherein the tangible storage medium further comprises bookmark prioritization profiles, wherein the prioritization handler and bookmark prioritization profiles are digitally encoded within the tangible storage medium in a computer-readable fashion, wherein the prioritization handler is operable to be run on hardware, wherein the prioritization handler when run is operable to:
detect an occurrence of a user-specified prioritization event for at least one of the bookmarks;
query a previously established and user configured one of the bookmark prioritization profiles for a record corresponding to the detected user-specified prioritization event, wherein said record defines a plurality of user-configured prioritization parameters for the at least one bookmark; and
dynamically modifying a position of the textual descriptor that corresponds to the at least one bookmark within the listing for the at least one bookmark within the listing is based upon the plurality of user-configured prioritization parameters, wherein the plurality of user-configured prioritization parameters comprises at least three of a triggering event, a priority level, a recurrence frequency, an action definition, and a termination action.

19. The system of claim 17, wherein the Web browser natively lacks support for bookmark annotations, wherein the annotative and prioritization bookmark manager and annotation handler are implemented as plug-ins for the Web browser.

20. The system of claim 17, wherein the Web browser natively lacks support for bookmark annotations, wherein the annotative and prioritization bookmark manager and annotation handler are implemented as Web services, wherein the Web services run in hosts remotely located from the device in which the Web browser runs.
